(19) United States
(12) Patent Application Publication
(10) Pub. No.: US 2005/0089385 A1
(43) Pub. Date: Apr. 28, 2005

(54) Anti-rotation locking nut and bolt

(76) Inventor: Yen-Tseng Lin, Miao-Li Hsien (TW)

Correspondence Address: SUPREME PATENT SERVICES, POST OFFICE BOX 2339, SARATOGA, CA, 95070, US

(21) Appl. No.: 10/948,721

(22) Filed: Sep. 22, 2004

(30) Foreign Application Priority Data
Oct. 28, 2003 (TW) 092122961

(51) Int. Cl. F16B 39/10

(52) U.S. Cl. 411/154

(57) ABSTRACT

An anti-rotation locking nut (or bolt) is disclosed, including a nut (or bolt) body with a flange on the lower portion, wherein the under side of the nut (or bolt) body is ring-shaped with wavelike structures on the surface. The locking nut (or bolt) is used in conjunction with an anti-rotation packing fitted in between the article and the locking nut (or bolt). The cone shaped anti-rotation packing is formed with wavelike structures on the packing wall and made of compressible material having good elasticity. The wavelike structures on the under side of the locking nut (or bolt) and on the packing wall are to lock against each other to keep the locking nut (or bolt) in fixed position. The anti-rotation packing with the wavelike structures possesses good shock absorbing and cushioning effect to prevent the locking nut (or bolt) from inadvertent loosening.

### BACKGROUND OF THE INVENTION

1. Field of the Invention

The present invention relates to an anti-rotation locking nut (or bolt), and in particular to a locking nut (or bolt) which is able to increase the locking and shock-absorbing abilities and to prevent the locking nut (or bolt) from inadvertent loosening even under conditions of continued vibrations.

2. The Related Art

Bolts and nuts are commonly used to lock articles and join machine parts. A fastened bolt or nut is unlikely to be loosened by itself unless an outside force, for example vibrations, is applied. If a locked article is part of a motor or a wheel of a vehicle, subjecting to continuous vibrations, a rotational or moving force is gathered by the bolts and nuts locking the internal parts, so that the bolts and nuts of the internal parts may be set loose or fall off to cause a machine breakdown.

Ordinary locking bolts, such as rivets, have several metal pins over the shank portion that is to be driven into a locked article. The metal pins are to collapse when pushing into a threaded hole through the surface of an article, so that the deformed metal pins are pressed against the wall of the threaded hole to increase the locking effect. Another type of locking bolts has used several thorns on the shank portion. Still others have attempted to modify the structure of bolt threading to increase the gripping force inside the threaded hole. Though the use of these locking bolts and nuts ensures tight fastening of the article at one time, the shock-absorbing and cushioning effect against continuous vibrations have been largely ignored. In normal circumstances, when a locked article is subjected to constant vibrations of machine operation, the chance of advertent loosening of the locking bolts and nuts is proportional to the duration of machine operation time. Also, since these locking bolts and nuts are designed for one-time application, their locking ability can be drastically downgraded if the same bolt or nut is used again.

### SUMMARY OF THE INVENTION

The primary objective of the present invention is to provide an anti-rotation locking nut (or bolt), which prevents the locking nut (or bolt) from inadvertent loosening even under the condition of continued vibrations of a machine operation.

In accordance with another aspect of the present invention, the structure of the locking nut (or bolt) includes a nut (or bolt) body with a flange on the lower portion, where the under side of the nut (or bolt head) is ring-shaped and slightly dipping towards the center, and the under side has wavelike structures on the surface.

In accordance with still another aspect of the present invention, the locking nut (or bolt) is used in conjunction with an anti-rotation packing to be fitted in between the nut (or bolt head) and the locked article, where the anti-rotation packing is cone shaped with wavelike structures on the conical wall for increasing the fastening effect.

In accordance with still another aspect of the present invention, the wavelike structures on the packing wall are used to lock against corresponding structures on the under side of the nut (or bolt head) when the two opposing sides are compressed, so that the locking nut (or bolt) is able to prevent inadvertent loosening of the locking nut (or bolt) even under the condition of continued vibrations of a machine operation.

In accordance with still another aspect of the present invention, the curvatures of the wavelike structures on the packing wall and on the under side of the flange portion are to complement each other; in other words, the wavelike structures on one side are outward bending, whereas the wavelike structures on the opposite side are inward bending. When the locking nut (or bolt) is fastened, the wavelike structures on opposite sides are self-aligned and locked against each other.

In accordance with still another aspect of the present invention, the anti-rotation packing is made of compressible material with good elasticity and restorability, so that when the locking nut (or bolt) is fastened, the packing structures are squeezed and pressed on the ring-shaped under side of the flange portion producing a counter pressure.

In accordance with still another aspect of the present invention, the anti-rotation packing provides shock absorbing and cushioning functions in addition to the locking ability, so that the locking nut (or bolt) is able to prevent the locking nut (or bolt) from inadvertent loosening even under the condition of continued vibrations of a machine operation.

On the whole, the anti-rotation locking nut (or bolt) of the present invention possesses the following advantages over conventional locking nuts (or bolts): (1) good locking ability plus shock-absorbing and cushioning functions to prevent inadvertent loosening of the locking nut (or bolt) under conditions of continued vibrations, (2) reusability with no degradation of the locking ability, as the packing material possesses good elasticity, and the wavelike structures on the packing wall are treated by a thermal process, so that the packing can be restored to 80% of the original elasticity when retrieved from a loosened nut (or bolt), (3) competitive design, as the wavelike structures on the under side of the locking nut (or bolt) and on the wall of the anti-rotation packing can be easily reproduced to keep the production costs down, and (4) applicability to all types of locking nuts and bolts.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a perspective view of an anti-rotation structure of a locking nut in accordance with the present invention;

FIGS. 2A and 2B are cross-sectional views of a locking nut together with an anti-rotation packing before and after the locking nut is fastened;

FIG. 3 is an exploded view of the structure of an anti-rotation locking bolt of the second embodiment;

FIG. 4 is an exploded view of the structure of an anti-rotation locking bolt of the third embodiment;

FIG. 5 is an exploded view of an anti-rotation locking nut of the fourth embodiment;

FIGS. 6A and 6B are cross-sectional view of a locking nut of the fifth embodiment before and after fastened onto an article;

FIGS. 7A and 7B are cross-sectional view of a locking nut of the sixth embodiment before and after fastened onto an article;

FIGS. 8A and 8B are cross-sectional view of a locking nut of the seventh embodiment before and after fastened onto an article; and

FIGS. 9A and 9B are cross-sectional view of a locking bolt of the eighth embodiment before and after fastened onto an article;

### DETAILED DESCRIPTION OF THE PREFERRED EMBODIMENTS

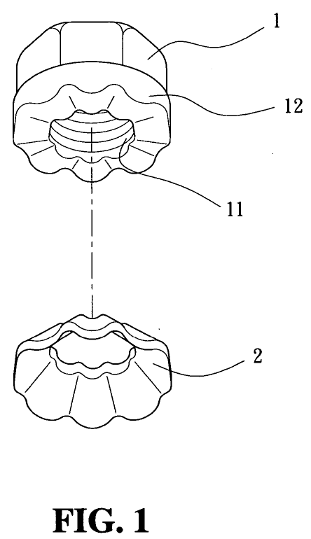

With reference to the drawings and in particular to FIG. 1, an anti-rotation locking nut (or bolt) in accordance with the present invention is depicted, which includes a hexagonal body 1 with inner threading surrounding a hollow center, and a flange 12 on the lower portion, where the under side of the flange portion is ring shaped and slightly dipping towards the center with wavelike structures on the under surface. The locking nut (or bolt) is to be used in conjunction with an anti-rotation packing 2, which is made of compressible material with good elasticity, and is shaped like a cone with wavelike structures on the surrounding wall.

The wavelike structures on the packing wall of the anti-rotation packing 2 are to correspond to the wavelike structures on the under side the flange portion 12, whereas the curvatures of the wavelike structures on the packing wall and the flange portion 12 are to complement each other; in other words, the curvature of the wavelike structures on one side is outward bending, whereas the curvature of the wavelike structures on the opposite side is inward bending.

When the anti-rotation packing 2 is compressed during fastening of the locking nut, the anti-rotation packing 2 is squeezed to produce a counter-pressure against the under side of the flange portion 12 of the locking nut (or bolt) to keep the locking nut in fixed position. Further, the wavelike structures on the packing wall also possess good shock-absorbing and cushioning function other than the normal locking ability. The anti-rotation structures are able to prevent the locking nut (or bolt) from inadvertent loosening when subjected to continued vibrations of a machine operation.

The anti-rotation packing 2 is made of compressible material with good elasticity, endurable, and abrasion-proof, which is not the same as that made up the locking nut (or bolt) 1. The wall of the anti-rotation packing 2 is treated by a thermal process, so that the wavelike structures are able to demonstrate good elasticity even after the packing is retrieved from a loosened locking nut (or bolt). The packing wall is able to restore to 80% of the original form before compression, thus an anti-rotation packing 2 is reusable without significant degradation of the locking ability.

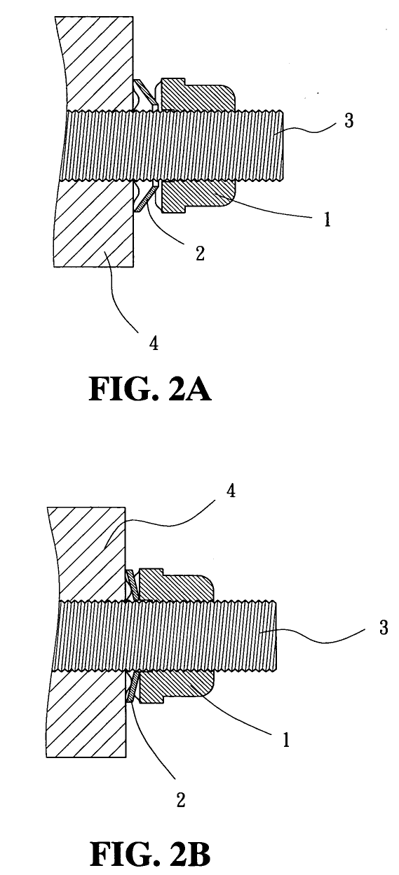

With reference to FIGS. 2A and 2B, in accordance with the first embodiment of the present invention, the anti-rotation packing 2 has a cone shape with wavelike structures on the packing wall. When the locking nut 1 is fastened, the anti-rotation packing 2 inserted between the locked article 4 and the locking nut 1 is squeezed to produce a counter-pressure against the under side of the nut body (as shown in FIG. 2B), so that the locking nut 1 and bolt 3 are tightly fastened with no risks of loosening even under the condition of continued vibrations of a machine operation.

In accordance with the present invention, the anti-rotation packing 2 inserted between the locking nut 1 and the locked article 4 possesses good elasticity and is able to absorb the vibrations of machine operation. The wavelike structures on the packing wall 2 and on the under side of the flange portion 12 are self-aligned and locked against each other when the packing 2 is compressed or squeezed. This feature of the locking nut is able to enhance the locking ability, thus ensuring tight fastening and preventing inadvertent loosening of the locking nut.

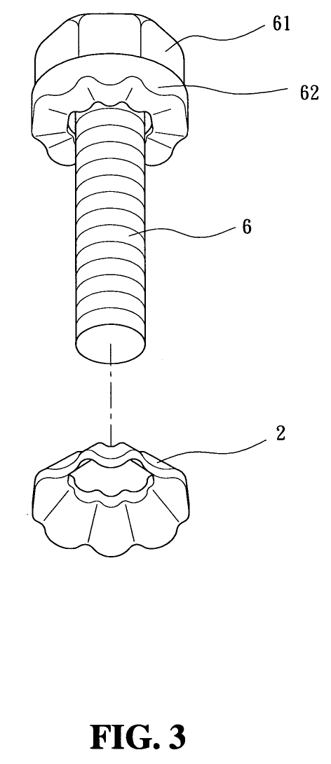

With reference to FIG. 3, the second preferred embodiment of the invention is depicted, where the locking bolt includes a bolt body 6 with threading on the outer wall of the shank portion, and a hexagonal head 61 on the upper portion, and the rest of the components are identical to those previously identified in the first embodiment. The lower portion of the bolt body 6 is a flange 62, and the under side of the bolt body 6 is ring-shaped and slightly dipping towards the center, with wavelike structures on the under surface, which is to correspond to the wavelike structures on the packing wall of an anti-rotation packing 2. The anti-rotation packing 2 same as the previous examples possesses good locking ability as well as shock-absorbing ability. Further, the anti-rotation packing structures are equally applicable to locking nuts and bolts.

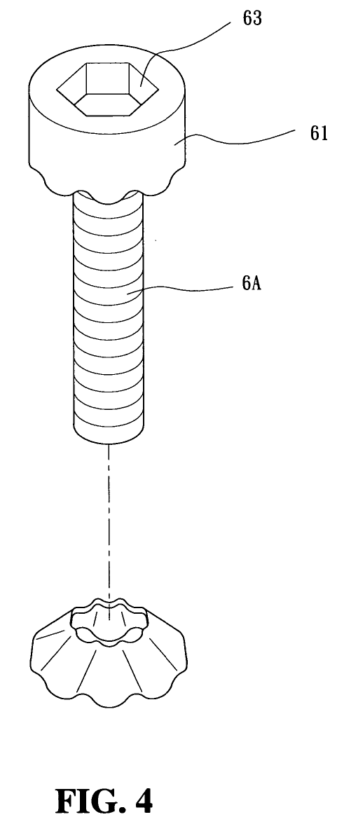

With reference to FIG. 4, the third embodiment of the invention is depicted, where the structure of the locking bolt is almost the same as that shown in FIG. 3, only that the bolt head 61 has a hexagonal hole 63 in the center of the top surface that is for a hexagonal wrench.

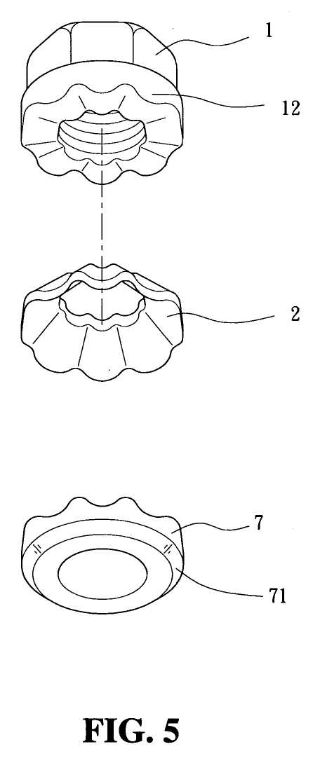

With reference to FIG. 5, the fourth embodiment of the invention is depicted, where the locking nut 1 is primarily to be used on articles with conical holes, such as the disk of a wheel. The structure of the locking nut 1 includes a nut body, anti-rotation packing 2, and a ring-shaped fitting 7, where the fitting ring 7 is a metallic ring with wavelike structures on the top edge, which is to correspond to the wavelike structures on the under side of the flange portion 12. The fitting ring 7 is in the form of a sloped ring 71, which is to be fit into a hole on the disk of the wheel for securing the anti-rotation packing 2 in fixed position. When the locking nut 1 is fastened, the anti-rotation packing 2 in between the flange portion 12 and the fitting 7 is compressed against the under side of the locking nut 1, thus preventing the locking nut 1 from inadvertent loosening. With the addition of this fitting ring, the anti-rotation locking nut can be applied on a wide variety of articles with different shapes and surfaces.

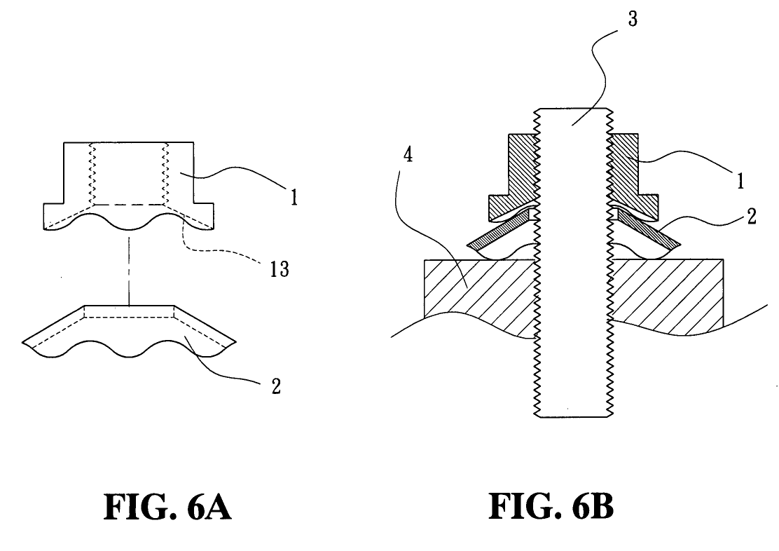

With reference to FIGS. 6A and 6B, the fifth embodiment of the invention is depicted, where the locking nut 1 is used in conjunction with an anti-rotation packing 2 same as the previous examples, only that the under side of the locking nut 1 is slightly dipping towards the center and has wavelike structures 13 on the under surface to correspond to the wavelike structures on the packing wall 2. When the locking nut 1 is fastened, the anti-rotation packing 2 is squeezed and thrusts towards the ring-shaped under side of the nut body, so that the wavelike structures of the anti-rotation packing 2 and the ring-shaped under side of the nut body will be locked with each other to prevent the locking nut from inadvertent loosening. Also, the structure of the anti-rotation packing 2 same as the previous examples possesses good shock-absorbing and cushioning function. If the anti-rotation packing 2 is used on a locking bolt 6, the wavelike structures are formed on the under side of the bolt head 61 surrounding the periphery in the form of a ring.

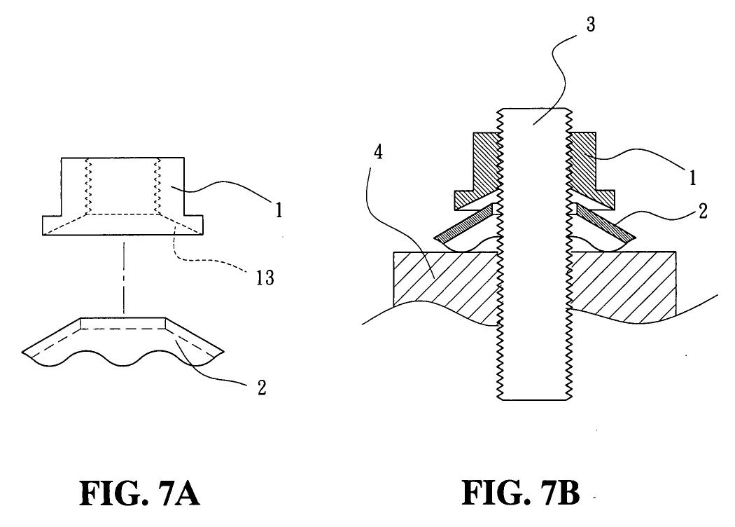

With reference to FIGS. 7A and 7B, the sixth embodiment is depicted, where the under side structure of the locking nut 1 is different from the previous example, in that the under side of the locking nut 1 is still ring-shaped and slightly dipping towards the center, but does not have wavelike surface 13, but the anti-rotation packing 2 still retains the wavelike structures on the packing wall. When the locking nut is fastened, the anti-rotation packing 2 is squeezed and thrusts towards the under side of the nut body, so that the conical packing wall 2 is self-aligned with the central cavity on the under side of the nut body. The pressure mounted on the locking nut also provides a cushioning effect that can further prevent the locking nut from inadvertent loosening.

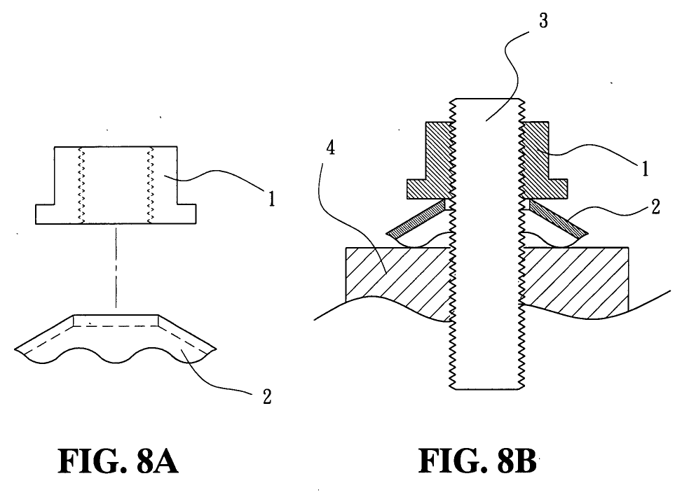

With reference to FIGS. 8A and 8B, the seventh embodiment of the invention is depicted, where the nut body has the structure of a conventional nut with flat surface on the under side, but the locking nut is used in conjunction with a conical anti-rotation packing 2. When the locking nut is fastened, the wavelike structures on the packing wall 2 is squeezed and thrusts towards the under side of the nut body to keep the locking nut in fixed position. The anti-rotation packing 2 with the anti-rotation structure has the shock absorbing ability and the locking ability. This structure same as the previous examples is able to prevent inadvertent loosening of the locking nut, with locking ability better than conventional locking nuts, but slightly below several embodiments described earlier.

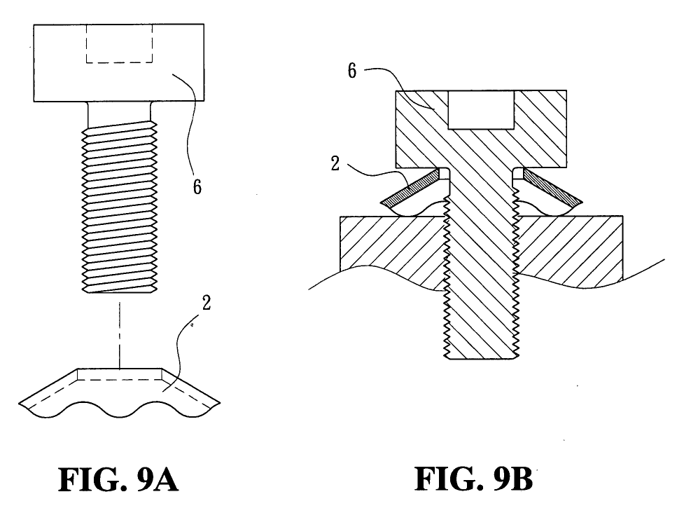

With reference to FIGS. 9A and 9B, the eighth embodiment of the invention is depicted, where the bolt body 6 has the structure of a conventional bolt with flat under surface, but the locking bolt is used in conjunction with a conical anti-rotation packing 2. When the locking bolt is fastened, the wavelike structures on the packing wall 2 is squeezed and thrusts towards the under side of the bolt head to keep the locking bolt in fixed position. The anti-rotation packing 2 with the anti-rotation structure has the shock-absorbing ability and locking ability. This structure same as the previous examples is able to prevent the locking bolt from inadvertent loosening, but the locking ability is slightly below several embodiments described earlier.

Although the present invention has been described with reference to the preferred embodiment thereof, it is apparent to those skilled in the art that a variety of modifications and changes may be made without departing from the scope of the present invention which is intended to be defined by the appended claims.

1. An anti-rotation locking nut, comprising a nut body with inner threading surrounding a hollow center, and a flange on the lower portion of the nut body, wherein the under side is ring shaped and dipping toward the center with wavelike structures on the surface, which corresponds to structures on the wall of an anti-rotation packing fitted in between the locking nut and the article surface, wherein the anti-rotation packing is cone shaped and made of compressible material.

2. The anti-rotation locking nut as claimed in claim 1, wherein the curvatures of the wavelike structures on the under side of the nut body and on the packing wall of the anti-rotation packing are to complement each other, so that when the locking nut is fastened, the wavelike structures on opposite sides are locked against each other to keep the locking nut in fixed position.

3. The anti-rotation locking nut as claimed in claim 1, wherein the anti-rotation packing is made of compressible material possessing good elasticity, endurable and abrasion proof.

4. The anti-rotation locking nut as claimed in claimed 1, wherein the flange on the lower portion of the nut body is ring shaped with wavelike structures on the under surface.

5. The anti-rotation locking nut as claimed in claimed 1, wherein the locking nut is used in conjunction with an anti-rotation packing, which is cone shaped with wavelike structures on the conical wall.

6. An anti-rotation locking bolt, comprising a bolt body and a bolt head, wherein a flange is formed on the lower portion of the bolt head, and the under side of the bolt head is ring shaped with wavelike structures on the surface, which is to be locked against corresponding structures on the wall of the anti-rotation packing when the locking bolt is driven into the locked article, wherein the anti-rotation packing is cone shaped and made of compressible material possessing good elasticity.

7. The anti-rotation locking bolt as claimed in claimed 6, wherein the bolt head of the locking bolt has a hexagonal shape.

8. The anti-rotation locking bolt as claimed in claimed 6, wherein the bolt head of the locking bolt has a hexagonal hole in the center of the top surface.

9. The anti-rotation locking bolt as claimed in claimed 6, wherein the bolt head of the locking bolt is ring-shaped with wavelike structures on the under surface.

10. An anti-rotation locking nut, comprising a nut body having inner threading surrounding a hollow center, to be used in conjunction with an anti-rotation packing, wherein the under side of the locking nut is ring shaped with wavelike structures on the surface to correspond to the structures on the wall of the anti-rotation packing, which is cone shaped and made of materials with good elasticity.
